(19) United States
(12) Patent Application Publication
(10) Pub. No.: US 2015/0219298 A1
(43) Pub. Date: Aug. 6, 2015

(54) Headlamp for Vehicles

(71) Applicant: Hella KGaA, Lippstadt (DE)

(72) Inventors: Ingo Möllers, Rietberg (DE); Wolfgang Pohlmann, Lippstadt (DE); Thomas Vieregge, Dortmund (DE)

(21) Appl. No.: 14/562,070

(22) Filed: Dec. 5, 2014

(30) Foreign Application Priority Data
Dec. 11, 2013 (DE) 102013114264.8

(51) Int. Cl. F21S 8/10

(52) U.S. Cl. CPC F21S 48/115; F21S 48/125; F21W 2101/10

(57) ABSTRACT

A headlamp for vehicles with a semiconductor-based light source arrangement including a number of chips with a matrix-type arrangement of the light sources for the forming of a light source group. Neighboring light sources have an equidistant distance relative to one another. The headlamp also includes an optics unit for the projection of the light sources to form a given light distribution. At least two light source groups are arranged on a common carrier, and a group distance between neighboring light source groups is larger than the distance between the neighboring light sources of the respective light source groups. The light source groups are assigned a common optics unit, and the optics unit being configured so that border light sources of neighboring light sources groups arranged on edges of the respective neighboring light source groups and facing one another are projected to form overlapping light spots. The border light sources are dimmed down so that the overlapping light spots have an illuminance lying within a desired value deviation of the illuminance of the neighboring light spots. The neighboring light spots being projected by depiction of the light sources are situated next to the border light sources of the respective light source groups.

### CROSS REFERENCE

This application claims priority to German Application No. 10 2013 114264.8, filed Dec. 18, 2013, which is hereby incorporated by reference.

### FIELD OF TECHNOLOGY

The invention relates to a headlamp for vehicles with a semi-conductor-based light source arrangement, comprising a number of chips with a matrix-type arrangement of the light sources for the forming of a light source group, wherein neighboring light sources have an equidistant distance relative to one another, and with an optics unit for the projection of the light sources to form a given light distribution.

### BACKGROUND

A headlamp for vehicles is known from DE 10 2005 041 234 A1, which has a semiconductor-based light-source arrangement as well as an optics unit in front of it. The light source arrangement has two light source groups, each having a number of light sources being arranged matrix-type on a common chip. The light source groups are spatially separated. The optics unit comprises at least two lenses. The light source groups are assigned different lenses, so that the light sources of the different light source groups are projected to form light spots of different sizes, so that by a superposition of these light spots of different sizes, a given light distribution, resp. a low-beam light distribution, can be achieved.

In the known headlamp, it is disadvantageous, that the space requirement is, especially due to the number of lenses, relatively large. The light source groups each consist of LED-light sources which have been produced in one chip. If several so-called LED-chips were projected by a single lens to achieve a more compact design, the problem arises, that due to the design of such LED-chips on a common carrier, a group distance between the LED-chips is larger than a distance between neighboring LED-light sources within the LED-chip. A “lattice-fence” effect appears, in which dark spots occur in the light distribution, leading to inhomogeneities in the light pattern (low beam light distribution etc.).

### SUMMARY OF THE INVENTION

It is, therefore, the task of the present invention to develop a headlamp for vehicles having a semiconductor-based light source arrangement, in which light sources are provided in the shape of several chips, so that via a common optics unit several light source groups, each being arranged on a chip, are projected to form a given light distribution having no undesirable inhomogeneities caused by the relatively large distance between the light source groups.

To solve this task, an embodiment of the invention includes:
at least two light source groups arranged on a common carrier, wherein the group distance between neighboring light source groups is larger than the distance between the neighboring light sources of the respective light source groups,
wherein the light source groups are assigned a common optics unit,
wherein the optics unit is configured so that
   border light sources of neighboring light sources groups arranged on edges of the respective neighboring light source groups and facing one another are projected to form overlapping light spots and that
   the border light sources are dimmed down to an extent, that the overlapping light spots have an illuminance lying within a desired value deviation of the illuminance of the neighboring light spots, the neighboring light spots being realized by projection of the light sources being situated next to the border light sources of the respective light source groups.

According to an embodiment of the invention, an optics unit is assigned to several light source groups, each being arranged as different chips, but on a common carrier resp. substrate. To avoid the appearance of dark areas (“lattice fence” effect), the optics unit is embodied so that light sources on the edges (border light sources) of neighboring light source groups are projected to form preferably fully overlapping light spots, where otherwise a dark area would appear.

Furthermore, these border light sources are controlled resp. dimmed down by means of reducing the brightness value in comparison to other light sources of the respective light source group, so that the overlapping light spots have a luminance lying within a desired value deviation of the luminance of neighboring light spots. Advantageously, a homogeneous light distribution is achieved, in which light sources situated on the edge (border light sources) of a light source group can have a larger distance to neighboring light sources situated on the edge (border light sources) than to neighboring light sources of the same light source group. Herein it is accepted that a line and/or column of light sources cannot contribute to the illumination of different areas of the light distribution.

The basic idea of the invention is to align lines and/or columns of different light source groups in pairs on the same line-shaped area of the light distribution, while the dimming of these light sources creates a homogeneous transition to neighboring line-shaped areas of light distribution.

According to a preferred embodiment of the invention, the light sources situated on the edges (border light sources) are each dimmed down in comparison to neighboring light sources of the same light source group, so that the sum of their luminance has the same value as the luminance of the neighboring light sources. Advantageously, a homogeneous luminance transition from the light spots which do no overlap to the overlapping light spots is achieved by this means.

According to a further development of the invention, the optics unit is embodied so that border light sources of neighboring light source groups are projected to form predominantly or completely overlapping light spots.

According to an embodiment of the invention, the optics unit is embodied so that the light sources of the light source groups which are not arranged one an edge facing a neighboring light source group, are projected to form non-overlapping or slightly overlapping light spots. The number of the light sources required for a light distribution can hereby be advantageously limited.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a top view into a light source arrangement with two LED chips,

FIG. 2A is a schematic lateral view of a headlamp according to the state of the art with a dark area in the light distribution,

FIG. 2B is a schematic lateral view of a headlamp with a superimposed area in the light distribution,

FIG. 2C is a schematic lateral view of a headlamp according to the invention with a homogeneous light distribution and

FIG. 3 is a luminance diagram.

### DETAILED DESCRIPTION OF THE DRAWINGS

A headlamp according to the invention can be used to generate a low-beam or a high-beam function as well as e.g. generate a bend lighting or marker light function. The headlamp comprises essentially a semiconductor-based light source arrangement 1 as well as an optics unit 2 arranged in front of the light source arrangement 1 in the main radiation direction H.

The optics unit 2 may consist of a single lens. Alternatively, the optics unit 2 can also consist of several lenses, which are arranged one behind the other in the main radiation direction H.

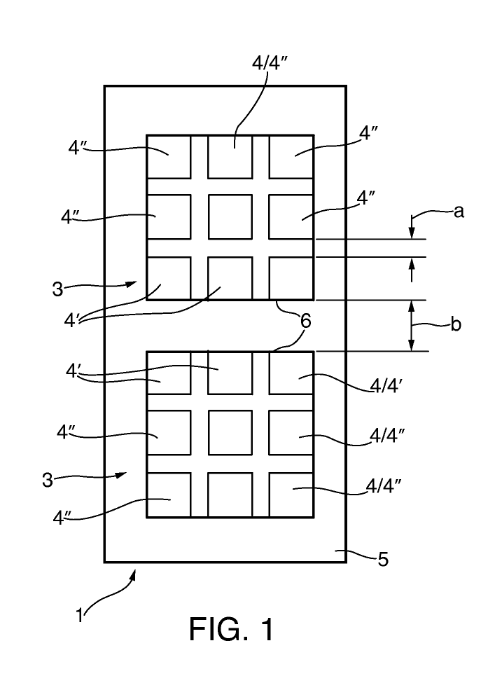

The light source arrangement 1 comprises several light source groups 3, of which only two are depicted exemplarily in FIG. 1. The light source groups 3 are each embodied as a chip, on which a multitude of LED light sources 4 is arranged matrix-type, i.e. in lines and columns forming an uniform distance a between neighboring LED light sources 4. The distance a can be regarded as a pixel distance. For a simplified illustration, chips with 3×3 pixel only are represented in FIG. 1. Distance a is in the μm-range.

The light source groups 3 resp. LED chips are arranged at a group distance b relative to another. Group distance b is larger than the distance between the neighboring LED light sources 4 in each light source group 3. The group distance b is therefore a multiple of the distance a. In the present exemplary illustration the group distance b is three times as large as distance a.

The light source groups 3 (LED chips) are arranged on a common carrier 5 serving as the substrate of the light source arrangement 1. The light source groups 3 are therefore integrally connected to one another and extend preferably in a plane running vertical to an optical axis A of the headlamp.

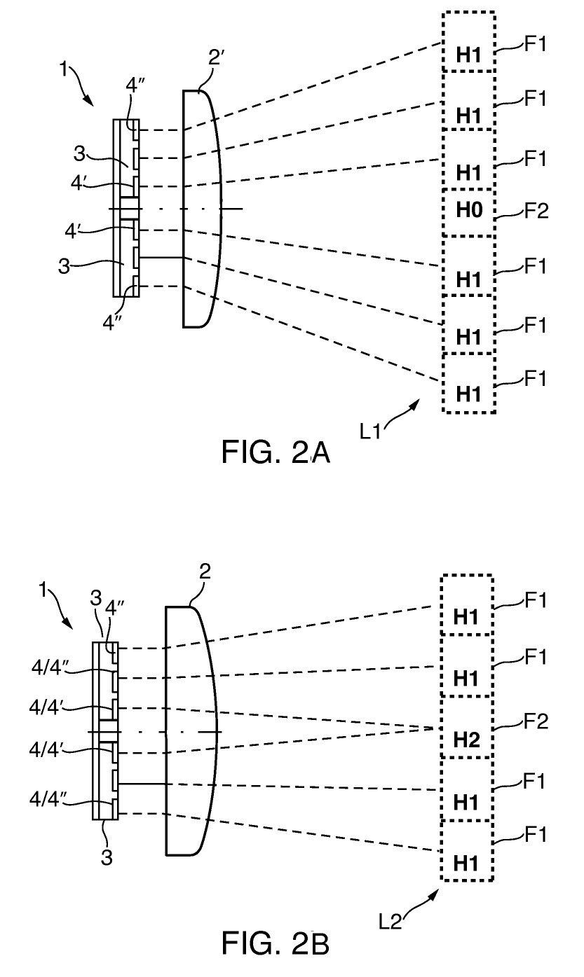

In conventional headlamps with an optics, unit 2′ according to FIG. 2A, the LED light sources 4 would be projected to form light spots F1 with a luminance H1, having a brightness value resp. luminance value according to the given light distribution. The optics unit 2′ is laid out so that neighboring light spots F1 are arranged in a little or non-overlapping manner. Due to the relatively large group distance b, a line-shaped dark area F2 having a luminance H0 equaling zero occurs, which may be called “lattice fence” effect. It results in an inhomogeneity of the light distribution L1, which is eliminated by the invention.

According to the invention, the optics unit 2 is configured resp. laid out so that LED light sources 4′ (border light sources) arranged on edges 6 of neighboring light source groups facing one another are projected to form light spots F2, which are arranged predominantly overlapping or fully overlapping. If the border light sources 4′ were activated with the same brightness as the neighboring light sources 4″, the light spot F2 would have twice as high a luminance value H2 as the luminance value H1 of the neighboring light spots F1, see light distribution L2 in FIG. 2B.

According to the invention, the border light sources 4′ are activated in a dimmed manner, so that the light sources 4′ are each projected to form light spots F2 with half the luminance value of the light spots F1. Due to the local superimposition of the light spots F2 projected by the border light sources 4′, the given luminance value H1 occurs as generated in the neighboring light spots F1. The result is a homogeneous light distribution L3 as illustrated in FIG. 2C.

In FIG. 2B, a light distribution L2 with a inhomogeneity would be the result of a luminance value H2 which is twice as high in the light spots F2.

To achieve a homogeneous light distribution L3, it is of course not necessary that neighboring light spots F1, F2, have the same luminance value. It would be sufficient if the light spots F2 had a luminance value lying within a desired value deviation S of the luminance value H1 of the neighboring light spot F1. In the present example, the luminance value H1 of the neighboring light spots F1, resp. the brightness value of the neighboring light sources 4″ may serve as a desired value. The desired value deviation S may be up to +/−10% of the luminance value H1.

Preferably, the number of the light sources 4 or the respective light source groups 3 may be arranged identically. In particular, the number of border light sources 4′ of neighboring light source groups 3 is identical.

In the light source groups 3 the distances a between the lines and columns of light sources 4″ are embodied identically.

The light source arrangement 1 is switched on and/ or off by means of a driver unit which is not represented, and particularly the border light sources 4′ are operated in a dimmed manner.

In the present embodiment, the border light sources 4′ are each operated at 50% of the brightness value at which the neighboring light sources 4′ of the light sources groups 3 are operated.

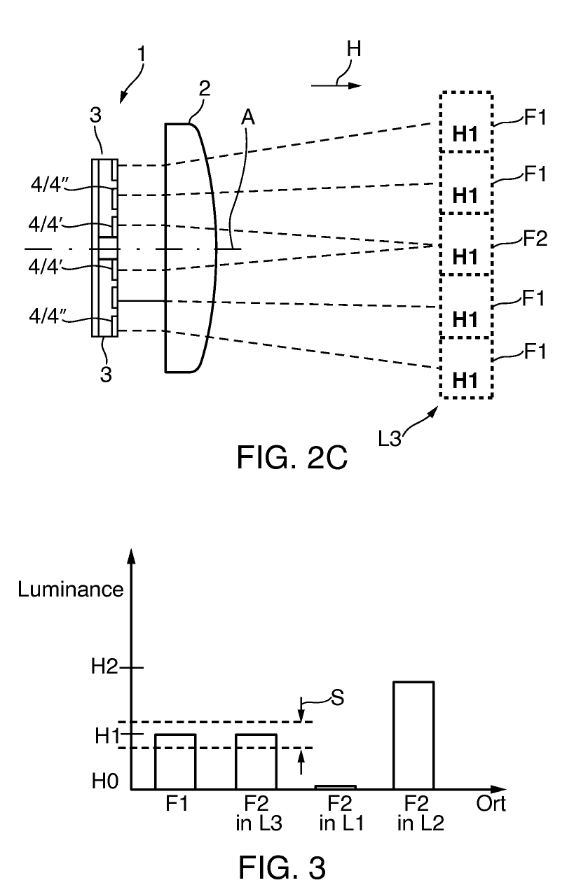

In FIG. 3 it can be seen that in FIG. 2C, according to the invention, the light spots F2 resulting from border light sources 4′ of neighboring light source groups 3 lie within the desired value deviation S. In the embodiment they have approximately the luminance value H1. The light spots F2 in the light distribution L1 according to FIG. 2A only have the luminance value H0 equaling zero, so that a dark strip is formed. The light spots F2 in the light distribution L2 according to FIG. 2B have a luminance value H2, which is twice as large as the luminance value H1.

### List of Reference Signs

1 Light source arrangement
2 Optics unit
3 Light source groups
4, 4′, 4″ LED light sources
5 Carrier
6 Edges
H Main radiation direction
a Distance
b Group distance
H0, H1,
H2 Brightness value
F1, F2 Light spot
L1, L2,
L3 Light distribution
S Desired value deviation

1. A headlamp for vehicles comprising:
a semiconductor-based light source arrangement, including:
a number of chips with a matrix-type arrangement of the light sources for the forming of a light source group, wherein neighboring light sources have an equidistant distance relative to one another, and
an optics unit for the projection of the light sources to form a given light distribution,
wherein at least two light source groups are arranged on a common carrier, wherein a group distance between neighboring light source groups is larger than the distance between the neighboring light sources of the respective light source groups,
wherein the light source groups are assigned a common optics unit,
wherein the optics unit being configured so that: border light sources of neighboring light sources groups arranged on edges of the respective neighboring light source groups and facing one another are projected to form overlap-ping light spots, and the border light sources are dimmed down so that the over-lapping light spots have an illuminance lying within a desired value deviation of the illuminance of the neigh-boring light spots, the neighboring light spots being projected by depiction of the light sources being situated next to the border light sources of the respective light source groups.

2. The headlamp according to claim 1, wherein the border light sources are controlled so that the sum of the luminance values of the overlapping light spots corresponds to the luminance values of the neighboring light spots, wherein the neighboring light spots are projected by the light sources neighboring the border light sources of the respective light source group.

3. The headlamp according to claim 1, wherein the light sources of the light source groups are arranged in columns and lines, wherein the number of border light sources arranged on edges facing one another of the light source groups is identical.

4. The headlamp according to claim 3 wherein the distances (a) between the light sources arranged in columns and lines within the light source groups are identical.

5. The headlamp according to claim 4 wherein the group distance (b) between neighboring light source groups is a multiple of the distance (a), by which the neighboring light sources of the same light source group are spaced relative to one another.

6. The headlamp according to claim 1 wherein the optics unit has at least one lens projecting the light sources of all light source groups to form the given light distribution.

7. The headlamp according to claim 1 wherein light source arrangement has a drive unit assigned to it, by means of which the light sources can be switched on and/or off and/or dimmed.

8. The headlamp according to claim 1 wherein the light sources are embodied as LED light sources.

9. The headlamp according to claim 1 wherein the border light sources of neighboring light source groups facing one another are embodied so that a predominantly overlapping or fully overlap-ping light spot is the result.

10. The headlamp according to claim 1 wherein the light sources of the light source groups, which are not arranged on one of the edges facing one another of the light source groups, are projected to form light spots, in which neighboring light spots are arranged little or non-overlapping.
